(19) United States
(12) Patent Application Publication
(10) Pub. No.: US 2007/0240131 A1
(43) Pub. Date: Oct. 11, 2007

(54) Application prototyping

(75) Inventor: William T. Sumerlin JR., Pleasanton, CA (US)

Correspondence Address: Kokka & Hsu, PC, Suite 250, 1001 N. Rengstorff Ave., Mountain View, CA, 94043-1748, US

(73) Assignee: Go Play Network, Inc., Los Altos, CA (US)

(21) Appl. No.: 11/390,856

(22) Filed: Mar. 28, 2006

(51) Int. Cl. G06F 9/45; G06F 9/445

(52) U.S. Cl. 717/139; 717/174

(57) ABSTRACT

Application prototyping is described, including designing a layout of a prototype associated with the application, creating a skin associated with the prototype, the skin being configured to provide a context associated with the prototype, developing a script configured to execute the prototype, and implementing the skin, the script, and the context associated with the prototype, the prototype being configured for user interaction.

### FIELD OF THE INVENTION

The present invention relates generally to software development. More specifically, application prototyping is described.

### BACKGROUND

In software development, there are several issues (e.g., design, usability, performance, compilation, and execution (i.e., run-time)) that affect the development of a computer software program or application (hereafter “application”). Due to the complexity of these issues, significant time and expense is incurred during a typical application development project using conventional development and programming techniques. Applications often require extensive debugging, testing, and quality assurance measures before a full public release or version can ship. “Buggy” or faulty applications that ship with problems in the underlying source code (hereafter “code”) or user interfaces often fail to do well in a commercial context. Commercialization of an application often requires focus groups, testing, quality assurance, advance previews (e.g., alpha, beta tests and products), and other measures to correctly assess and prepare an application for commercial or consumer release. However, conventional techniques can result in application development projects that span months or years.

In order to preempt a full-scale, time-consuming application development project's timeline, user-facing applications are often developed by creating “mock ups” or prototypes. However, these prototypes are not publicly released and typically used to “storyboard” or outline how a product (i.e., application) should appear, act, or function with a user. Conventionally, developing a prototype or demonstration of an application that does not diminish the commercial or consumer potential value without completely coding the underlying application is difficult. Conventional techniques such as “mock ups” only mimic the appearance or end user interface of an application without providing any existing or useful functionality. Applications such as PowerPoint® developed by Microsoft Corporation of Redmond, Wash. or Photoshop® by Adobe Systems Incorporated of San Jose, Calif. provide a forum for viewing mock-ups, but these are not useful on the intended end devices (e.g., mobile phones, PDAs, smart phones). Typically, application functionality is either very limited or completely non-functional. PowerPoint® is often used to show a mock up of an application, but with a complete lack of functionality (i.e., it is useful only for showing images or screen captures of an intended user interface). Conventional prototyping techniques require extensive time and labor and generally result in “mini” development projects that do not provide material that can be imported into a full-scale development project. Further, functionality intended for a full product rarely emerges in a prototype, which is very limited in functionality. Typically due to more complicated underlying code development, testing, and lower quality content (i.e., content that has not been properly modified for appearance on a given desktop, notebook, personal digital assistant, smart phone, mobile phone, or other type of computing device's screen), prototypes do not accurately convey the intended commercial or consumer value of an application. Conventionally, prototypes require time, money, and lengthy testing to determine whether a new user interface (“UI”) or new type of UI is appealing for an application. The new UI must be built (i.e., actual program development) and included into the prototype to understand the value and impact of a product that is being considered for development. This unscheduled, and often unbudgeted, activity significantly discourages new innovation with regard to UIs because of unknown, but potentially high costs and lack of user acceptance.

Thus, what is needed is a solution for demonstrating applications without the limitations of conventional implementations.

### BRIEF DESCRIPTION OF THE DRAWINGS

Various examples are disclosed in the following detailed description and the accompanying drawings:

FIG. 1A illustrates an exemplary system for application prototyping;

FIG. 1B illustrates an alternative, exemplary system for application prototyping;

FIG. 2A illustrates an exemplary studio module for application prototyping;

FIG. 2B illustrates an exemplary player module for application prototyping;

FIG. 3 illustrates another alternative, exemplary system for application prototyping;

FIG. 4A illustrates an exemplary overall process for application prototyping;

FIG. 4B illustrates an exemplary process for identifying user interfaces;

FIG. 4C illustrates an exemplary process for developing prototype scripts;

FIG. 5A illustrates a view of an exemplary prototype configured for user interaction;

FIG. 5B illustrates an alternative view of an exemplary prototype configured for user interaction;

FIG. 5C illustrates another alternative view of an exemplary prototype configured for user interaction; and

FIG. 6 is a block diagram illustrating an exemplary computer system suitable for application prototyping.

### DETAILED DESCRIPTION

Various examples may be implemented in numerous ways, including as a system, a process, an apparatus, or as computer program instructions included on a computer readable medium such as a computer readable storage medium or a computer network wherein program instructions are sent over optical or electronic communication links. In general, the steps of disclosed processes may be performed in an arbitrary order, unless otherwise provided in the claims.

A detailed description of one or more examples is provided below along with accompanying figures. The detailed description is provided in connection with such examples, but is not limited to any particular example. The scope is limited only by the claims and numerous alternatives, modifications, and equivalents are encompassed. Numerous specific details are set forth in the following description in order to provide a thorough understanding. These details are provided for the purpose of example and the described examples may be implemented according to the claims without some or all of these specific details. For the purpose of clarity, technical material that is known in the technical fields related to the examples has not been described in detail to avoid unnecessarily obscuring the description.

Application prototyping techniques are described, including designing a layout of a prototype associated with an application, creating a skin associated with the prototype, the skin being configured to provide a context associated with the prototype, developing a script configured to execute the prototype, and implementing the skin, the script, and the context associated with the prototype, and the prototype being configured for user interaction after the script and the context are implemented. In some examples, application prototyping may be implemented using a studio module and a player module configured to develop a prototype for a given device, including generating and adapting content for display using the prototype without requiring underlying source code development. The described techniques also enable an application to be prototyped by using a studio module and a player module to develop, load, and run an application. In other examples, application prototyping may be implemented differently.

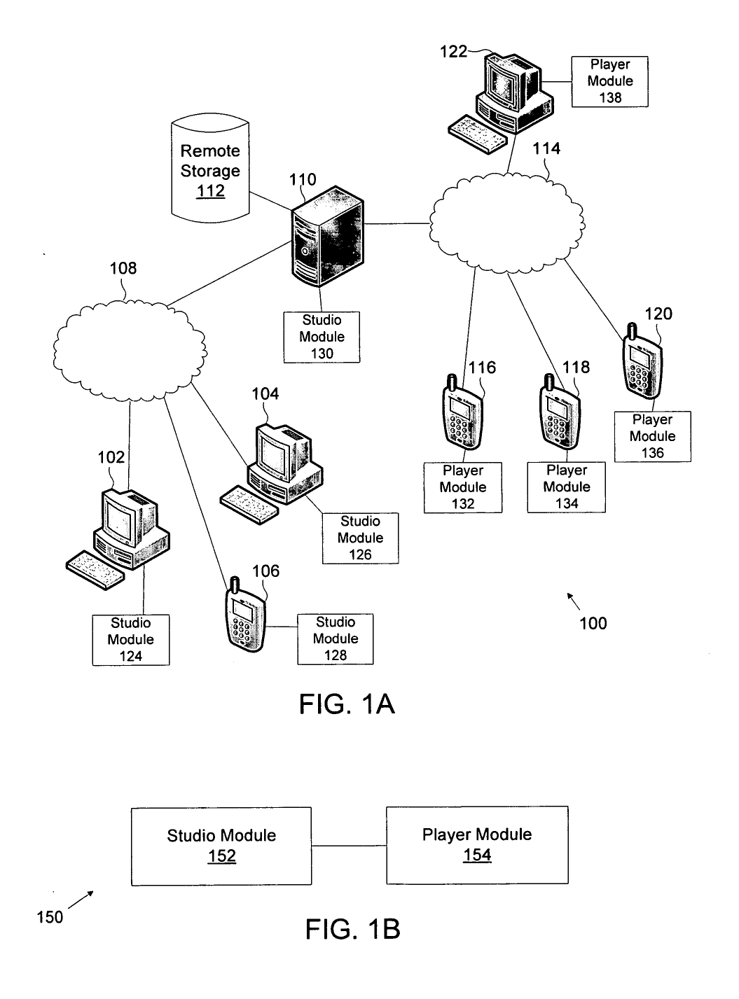

FIG. 1A illustrates an exemplary system for application prototyping. Here, system 100 includes personal computers 102-104, mobile computing device 106, networks 108 (e.g., Internet, LAN, WAN, MAN, and the like), server 110, remote storage database 112, mobile computing devices 116-120, personal computer 122, studio modules 124-128, and player modules 130-138. In some examples, system 100 may be implemented to develop prototypes of applications for deployment on servers, personal computers, personal or mobile computing devices, and other computing or processor-based implementations, some of which are shown and described.

As an example, an application may be prototyped using studio modules 124-130 and player modules 132-138. Application prototypes (hereafter “prototype” or “prototypes”) may be developed using studio modules 124-130 and deployed (i.e., “installed,” “loaded,” “downloaded,” “run”) to player modules 132-138. When deployed, prototypes may have functionality that enables user interaction or “prototype program flow,” such as navigating through content, selecting items in the prototype, providing user input resulting in responsive actions such as retrieving, recording, or downloading content, and others. Prototype program flow may also be modified through user input, environmental conditions (e.g., time, date, location, network condition) and analysis of information that is stored locally or remote. Prototypes may also be configured to provide functionality and features that are similar to a complete application, but without providing a complete code set. In other words, applications that enable a user to retrieve, download, manipulate, and perform other operations associated with content of an application may instead use a prototype that is developed to provide a substantially indistinguishable user experience from that of a fully-coded application. Here, studio modules 124-130 may be used to develop a prototype and player modules 132-138 may be used to “play” or run the prototype on an end device (e.g., mobile computing devices 116-120, personal computer 122, and other types of devices running a prototype and player module). Studio modules 124-130 may have different functionality than player modules 132-138 in order to permit the former to develop prototypes and the latter to allow user interaction. In other examples, system 100 and the above-described elements may be implemented using more, fewer, or different elements than those shown and described.

Here, a prototype may be developed on studio modules 124-130 using various devices, including a personal computer (e.g., personal computers 102-104), a handheld or mobile computing device 106, or on server 130, the latter of which may be implemented as an FTP server, file server, web server, application server, or a computer or device used by a system or network administrator, or the like. System 100, including personal computers 102-104, 122 and mobile computing devices 106, 116-120, may be implemented using a peer-to-peer, client-server, or other type of network architecture, but is not limited to the example shown. Further, personal computers 102-104, 122 and mobile computing devices 106, 116-120 may be varied in number, types, function, and structure, and are not limited to any particular implementation. In some examples, server 130 may also use web programming languages (e.g., PHP, C, HTML, and others) to augment a prototype or the environment of a prototype (i.e., a user or developer may extend the environment of her prototype). In other examples, and other web services to support studio modules 124-130 and/or player modules 132-138. A prototype may be developed using studio modules 124-130, transmitted over network 108 to another network (e.g., network 114), and loaded into one or more target devices (e.g., mobile computing devices 116-120, personal computer 122, and the like) using player modules 132-138. In some examples, networks 108-114 may be data networks that are used to transmit and receive data between end points (e.g., personal computers 102-104, 122 and mobile computing devices 106, 116-120) using wired, wireless, optical, or other types of data communication links. In other examples, personal computers 102-104, 122 and mobile computing devices 106, 116-120 may be configured in a data sharing network (e.g., peer-to-peer) where direct connections are provided between endpoints (not shown). Other variations of network configurations including personal computers 102-104, 122 and mobile computing devices 106, 116-120 may be implemented.

In some examples, system 100 and the various elements shown and described above may be implemented as hardware, software, circuitry, or a combination thereof. System 100 and the elements shown may be implemented as software that is developed using programming or formatting languages such as C, C++, .Net, Java, and others. Remote storage database 112 and other databases described herein may be implemented using databases and database schemas such as Oracle, SQL, MySQL, DB2, and others. System 100 and the above-described elements are not limited in function, structure, or implementation to the languages, protocols, schemas, or data structures listed above and may be implemented using some, all, or none of the languages described, including unstructured (e.g., COBOL, FORTRAN, Basic, DOS, machine assembly, and the like) and structured (i.e., object oriented, 3GL and 4GL languages, and the like) computer programming and formatting languages.

FIG. 1B illustrates an alternative, exemplary system for application prototyping. Here, system 150 includes studio module 152 and player module 154 configured in direct data communication. As an example of an alternative system implementation, system 150 may be implemented with studio module 152 in direct or indirect data communication with player module 154. Studio module 152 may be configured to develop a prototype and player module 154 may be directly or indirectly linked and configured to download or run a prototype on an end device (e.g., mobile computing devices 116-120, personal computer 122). In some examples, studio module 152 may include various editors (e.g., bitmap, text, and others) to adapt content for particular devices. In other examples, studio module 152 may be configured to upload a prototype to a server (e.g., server 110, file server, FTP server, web server, application server, and the like) for download to one or more player modules 154. Prototypes may be downloaded in part or in whole, and may also be configured for local execution on an end device (e.g., mobile computing device 116-120) or to stream content from a remote location (e.g., server 110 and remote storage 112). Here, the described techniques may be emulated using a text editor, picture/slide generator, and an upload/download program. A user can use the described techniques to develop a prototype with knowledge of desired file formats and a destination for uploading or downloading files.

In some examples, studio module 152 may include a state machine that is used to keep player module 154 updated. A state machine (not shown) may be used to track changes and states of studio module 152 and player module 154. When player module 154 is modified or updated, the state machine may be configured to register track these changes. The tracked changes may then be used to later update or further modify system 150, studio module 152, or player module 154. Further, system 150 is not limited to a particular device or display and states for various end devices may be tracked. Here, a single studio module (e.g., studio module 152) is shown in data communication with player module 154. However, one or more studio modules 152 and player modules 154 may be implemented to enable users to develop a prototype. In other examples, a single studio module 152 may be used to develop a prototype that is implemented and used on multiple player modules. In yet other examples, other combinations or variations may be implemented beyond those described above.

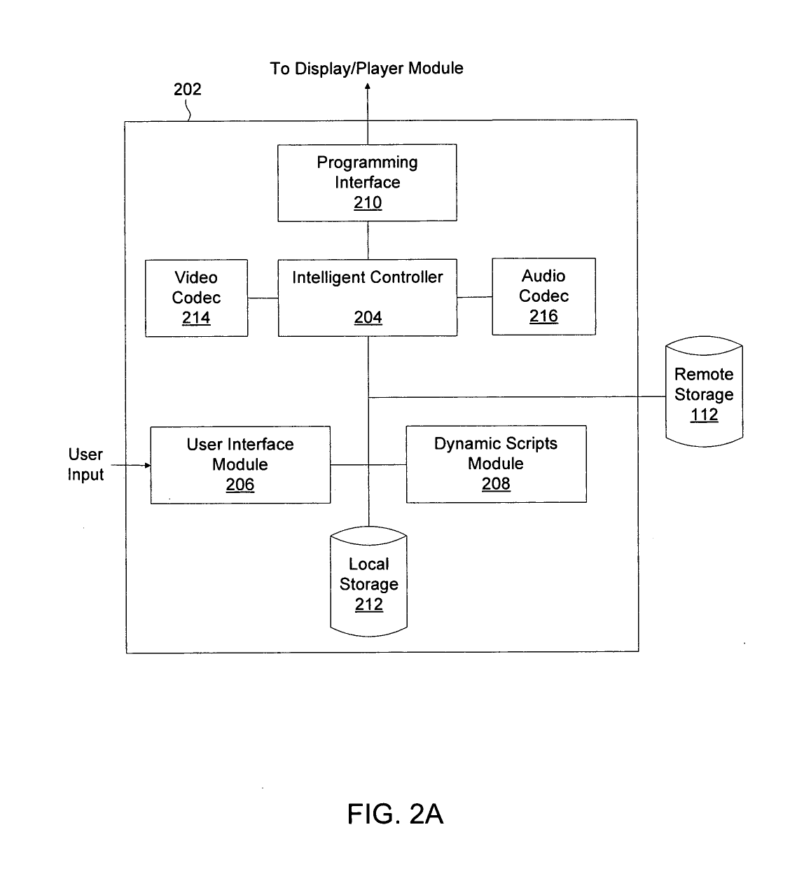

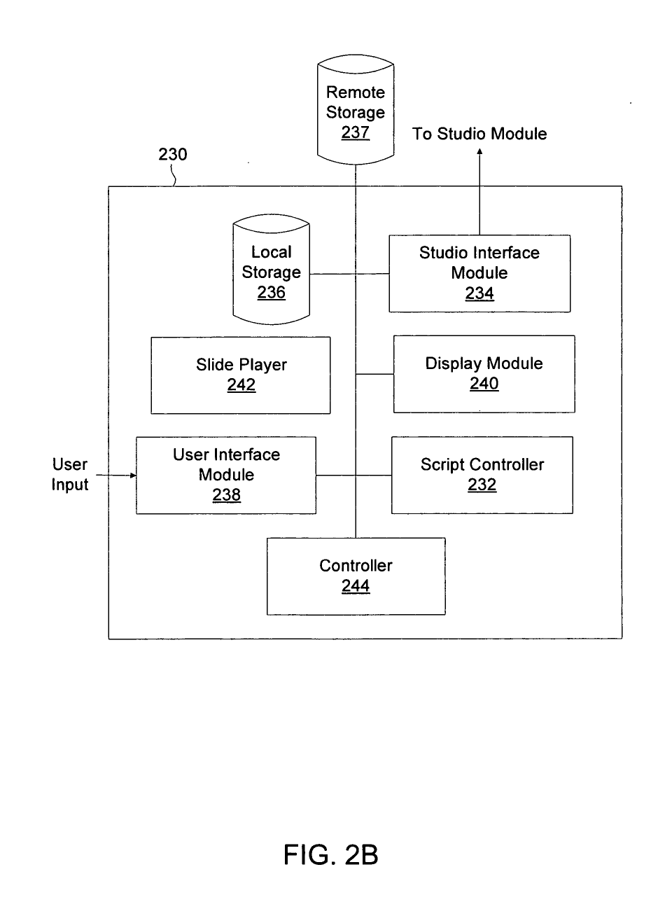

FIG. 2A illustrates an exemplary studio module for application prototyping. Here, studio module 202 includes intelligent controller 204, user interface module 206, dynamic scripts module 208, programming interface 210, remote storage database 112 (FIG. 1A), local storage database 212, video codec 214, and audio codec 216. Studio module 202 may be implemented differently using more, fewer, or other modules besides those shown and is not limited to the descriptions provided. Studio module 202 may also be implemented as studio modules 124-130 (FIG. 1A) or studio module 152 (FIG. 1B).

In some examples, intelligent controller 204 receives user input via user interface module 206, that is used to create scripts (i.e., computer applications or programs that, when executed, determine how content, functions, features, user input, and other aspects of prototypes are implemented and performed) for a prototype. Scripts may be generated using a script language that indicates a line #, designates content (e.g., pictures, images, audio and video files, graphics, and others), input keys configured to accept user input for interacting with the prototype, conditional statements (e.g., “IF” statements defining actions or operations that should be performed when a given input is provided), and others. Scripts (i.e., computer programs, applications, or routines known as “scripts” that are executed when a user input is received but, when executed, perform various functions in support of a prototype, including retrieving and displaying content, displaying user interface elements (i.e., “look-and-feel” elements such as frames and windows), dynamically presenting content in response to a given action, among others) may be created using dynamic scripts module 208 and stored in either local storage database 212 or remote storage database 112. In some examples, access to local storage database 212 and remote storage database 112 may occur through an operating system's file system and a SQL-type database (e.g., MySQL, and the like). In addition to dynamic scripts module 208, other modules, functions, or features may be implemented and used such as a bitmap editor, text editor, or an operating system for a particular type of device supported by studio module 202 or player modules 132-138. For example, user interface module 206 or programming interface 210 may be implemented to include a text and graphic/object editor.

For example, some phones may use a Java-based operating system such as Java 2 Micro Edition (“J2ME”), but studio module 202 may include a Java operating system to configure prototypes to run on Java-based mobile computing devices (e.g., mobile phones, smart phones, camera phones, and the like). Studio module 202 may also be used to load different types of prototypes. As another example, a prototype may be developed, but configured for loading into multiple types of phones using different operating systems (e.g., Binary Runtime Environment for Wireless (“BREW”), J2ME, and others). Here, bitmap editors may be used, along with screen parameters (e.g., pixel size of a display screen on mobile computing device 116-120) to configure content for a prototype to be played on a particular type of mobile phone screen or display. In other examples, storage of scripts created using dynamic scripts module 208 may be performed at various locations and is not limited to local, remote, or any other type of storage. Here, scripts created using dynamic scripts module 208 may be stored in local storage database 212 or remote storage database 112 (FIG. 1A) and loaded onto an end device having a player module (e.g. mobile computing devices 116-120, personal computer 122 (FIG. 1A)) configured to load and run the prototype. Prototypes developed using the described techniques may be run either locally or by “streaming” data from a server or other remote location to a player module resident on mobile computing device 132-136 or personal computer 122 (FIG. 1A). In some examples, a prototype structure or “shell” may be loaded and, when user input is received via a player module, additional information is retrieved from studio module 202 (e.g., data, content, or scripts from local storage database 212 or remote storage database 112) or from a remote storage location (e.g., remote storage 112 (FIG. 1A). In other examples, a prototype may be implemented differently.

In some examples, intelligent controller 204 may retrieve requested content (e.g., text, graphics, video, audio, and other types of information) for a prototype running on a player module (not shown). Intelligent controller 204 may also receive input such as parameters, data, and information that indicate what action or operation should be performed by the prototypes (e.g., what content to show, what “page” or “slide” to graphically display, how to navigate between pages of content of a prototype). As an example, if mobile computing device 116 (FIG. 1A) has a prototype running and requests a particular mpg file in response to a user input or action, studio module 202 may be called to retrieve the requested file from local storage database 212 or remote storage database 112 and, after performing encoding, if any (i.e., file translation is performed if a destination platform does not support the format of the current clip/picture) using video codec 214 and adapting it for delivery and display on the requesting mobile computing device 116 (FIG. 1A), send the file via programming interface module 210 to a player module (not shown) on the end device. Other types and forms of content may also be handled by studio module 202 and a player module in data communication with it.

Here, various types of encoding and decoding modules (e.g., video codec 214, audio codec 216) may be implemented and are not limited to the examples shown and described above. Other types and forms of content may be stored, served, created, modified, or deleted using studio module 202, which may be encoded/decoded using different codecs than those shown and described above. Further, other types of content are also not limited to the actions or operations described above. In some examples, studio module 202 may be used to not only “preview” capability of an application, but also prototype content, functionality, UI, and other aspects of an application that are indistinguishable from the fully-coded application. Various types of coding and encoding modules may be used to translate/pack or translate/unpack video and audio data streams (i.e., when recording video and audio from an original source, playing video and audio content in or on an audio/visual (“a/v”) player, and the like). Further, various types of coding and encoding modules may also be used to convert an a/v data stream from one format to another format for playing compatibility with a target player or a target communication method or media. In some examples, preview functionality may be implemented by incorporating a player module (e.g., player modules 132-138) into studio module 202, which would yield lower development and support costs by being able to preview a prototype “on the fly” and using a single application.

Other actions or operations may be performed during the development of a prototype. For example, a prototype may be developed to simulate a sports-related (e.g., baseball, basketball, football, curling, triathlon, skeet-shooting, and others) token-trading game where users can manipulate various user interfaces to view, trade, modify, exchange, buy, sell, view content, or choose other actions associated with tokens that are configured to represent individual players (e.g., professional, amateur, local, high school, famous, infamous, unknown, and other types of players). By designing a layout for the game, scripts may be generated and used to develop the structure of the game, indicating particular tokens or content that may be presented when a given user input or interaction is issued by player module 230 (described in greater detail below in connection with FIG. 2B) and received by studio module 202. Scripts developed for the prototype may give the appearance of a fully-functional application when user input is received. Thus, time, labor, and expense are saved and prototypes are rapidly developed in order to provide a demonstration of the game without having to perform more extensive design and coding operations (e.g., programming an interface between the game and a “back-end” reconciliation server enabling a commercial bank to reconcile commercial transactions purchasing, selling and trading-tokens). The above example is provided for illustrative and descriptive purposes and is not intended to limit the application prototyping techniques described herein.

FIG. 2B illustrates an exemplary player module for application prototyping. Here, player module 230 includes script controller 232, studio interface module 234, local storage database 236, remote storage database 237, user interface module 238, display module 240, slide player 242, and controller 244. In some examples, other modules implementing functionality such as video and audio players and picture display systems may be implemented with player module 230. Player module 230 may be implemented differently using more, fewer, or other modules besides those shown and is not limited to the description provided. In some examples, player module 230 may be implemented on mobile computing devices 116-120 or personal computer 122 (FIG. 1A). In other examples, player module 230 may be implemented on different end devices and is not limited to the examples shown.

Here, player module 230 downloads and stores scripts associated with a prototype. A prototype may be completely or partially stored on local storage database 236 residing on an end user device (e.g., PDA, handheld computing device, smart phone, cell phone, personal computer, desktop, notebook, server, or other device used to view and interact with a prototype). In some examples, a prototype may be implemented using a distributed architecture including some elements on player module 230 and other elements on studio module 202 or another remote, networked location (e.g., remote storage 112 (FIG. 1A)). As an example, a prototype may be distributed between an end device and a server or service that supplies content, data, or information to a prototype in response to user input. In still other examples, a prototype may be implemented differently than described.

Here, player module 230 communicates with studio module 202 (FIG. 2A) using studio interface module 234. Controller 244 processes user input, signals and requests from studio module 202, and other actions and operations associated with player module 230. When user input is received (e.g., a user pressing a button or otherwise making a selection in a prototype using keys on mobile computing devices 116-120, personal computer 122, and the like) at user interface module 238, script controller 232 and studio interface module 234 run a script associated with a prototype. In some examples, script controller 232 may also be used to download and integrate scripts developed on studio module 202, updating state information on the latter. In some examples, a prototype may be developed using a tree-structure to build a hierarchy of content that, when played on player module 230, appears as a fully-coded or implemented application. However, by developing scripts that are executed according to a hierarchy of actions and operations (e.g., forward, back, previous, select, run, display, display an image, display text, and others), a prototype may be implemented analogous to a set of “flip” slides. In other words, a prototype may be designed or “laid out” such that when a user interaction occurs, pre-determined content is presented. A prototype may be implemented to appear as though an application was laid out, designed, coded (i.e., programmed), developed, and implemented to support various functions on an end device.

In some examples, an installed script determines, when executed, what action or operation to perform (e.g., showing a sub-menu, retrieving content based on the user input, and others). For example, a user input indicates an image, graphic, text, or slide is requested to be viewed using the prototype. When the script is executed, script controller 232 and studio interface module 234 run the relevant scripts (i.e., scripts associated with displaying the image or slide and the user interface that should be displayed with the image or slide (e.g., a frame, window, or other user interface element)) and determine whether the content requested is stored on local storage database 236, which may be implemented as local memory resident on mobile computing devices 132-136 or remote storage database 237. In some examples, controller 244 may include logic that enables player module 230 to connect through the Internet or other networks to a web site or file system using standard communication protocols (e.g., TCP/IP, UDP, and others) to exchange data. If the content is stored in memory locally, the content may be retrieved and then displayed on a screen using slide player 242, display module 240, or another display interface (not shown). In some examples, player module 230 may be implemented differently and is not limited to the above-described examples.

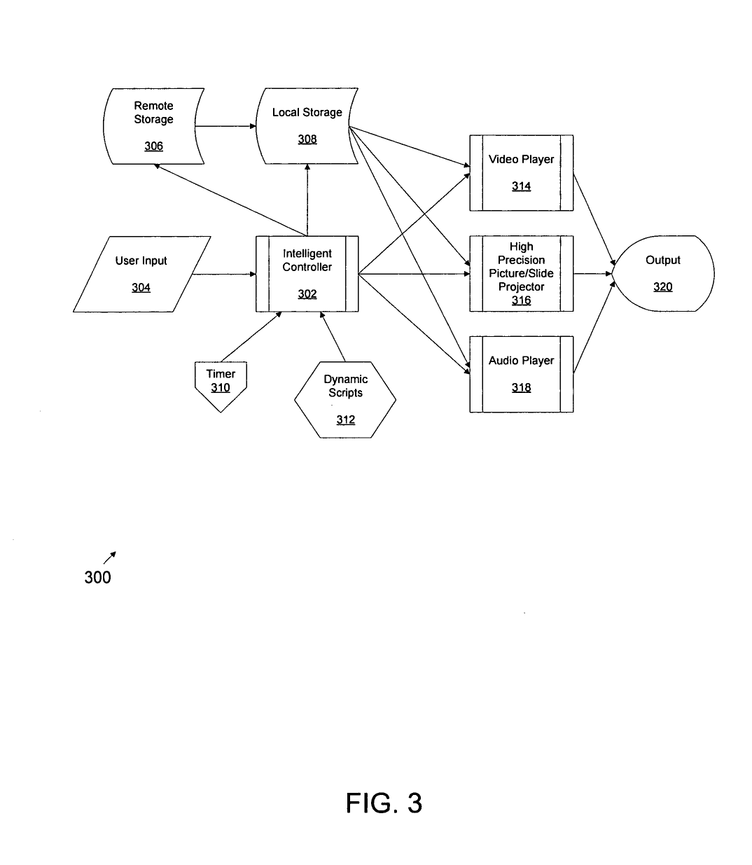

FIG. 3 illustrates another alternative, exemplary system for application prototyping. Here, an alternative view of an application prototyping system is shown, including system 300 with intelligent controller 302, user input 304, remote storage 306, local storage 308, timer 310, dynamic scripts 312, video player process 314, high precision picture/slide projector process 316, audio player process 318, and output 320. In other examples, more, fewer, or different processes may be implemented to support different types of actions and operations (e.g., haptic effects such as vibrations). In some examples, intelligent controller 302 receives user input to a prototype (e.g., a user selects an option presented on a display associated with the prototype). Timer 310 is used to synchronize or provide a timing signal to coordinate operations performed within system 300. Dynamic scripts may be applications that determine what data is retrieved from remote storage 306 or local storage 308 and sent to an output process (e.g., rendering, video player process 314, high precision picture/slide projector process 316, audio player process 318, or the like) and sent as output 320. In some examples, access may occur over the Internet or web to access data from web sites using communication protocols and standards such as http or ftp. The functions, processes, items, and data shown may be implemented using one or more elements (e.g., studio module 202, player module 230) and are not limited in function, structure, or implementation to the previous examples provided.

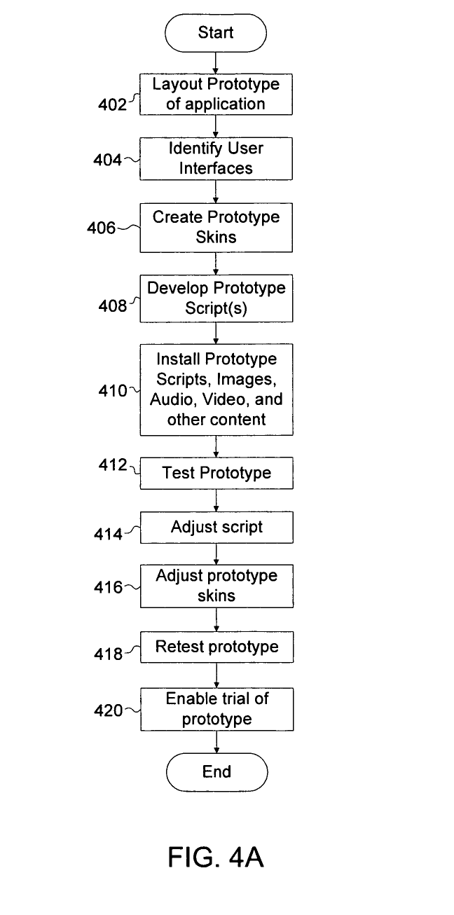

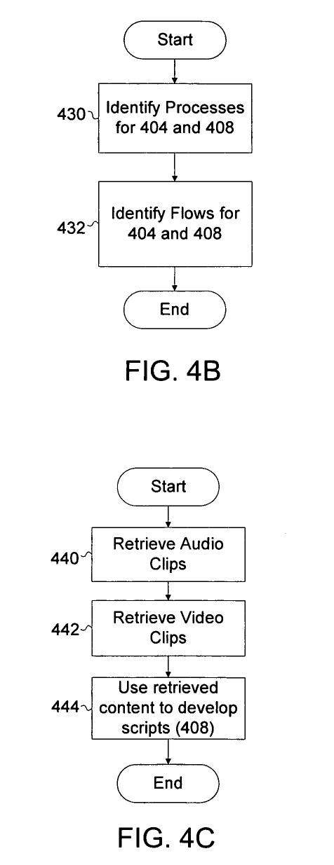

FIG. 4A illustrates an exemplary overall process for application prototyping. In some examples, a layout of an application prototype is determined (402). Once a layout has been determined, user interfaces associated with the product are identified (404). A skin for the prototype is then created (406). In some examples, a “skin” may be a user interface or set of user interfaces that provide content, context, and options for user interaction. For example, a baseball-themed skin may be created for a prototype and used for a game where users view, modify, trade, buy, sell, or exchange tokens representing a baseball player, team, mascot, or other personality. A skin may be implemented such that the game has a given “look and feel” (i.e., of a baseball game, baseball park). After identifying user interfaces and a skin or set of skins for the prototype, scripts are developed that serve as the underlying program code that ties the content and functionality of the prototype together (408). When a user interacts with the prototype, a direct (i.e., user-prompted) or indirect (i.e., system-specified action prompted in response to a user input) action may invoke a script. When the script (or set of scripts), skin (or set of skins), and user interfaces are determined, the prototype may be installed with the scripts, images, and associated content such as video and audio clips, graphics, images, photos, text, and other types of content (410).

In some examples, installation may include implementing the prototype from studio module 202 (FIG. 2A) to server 110 (FIG. 1A) or downloaded to player module 230. A prototype may be downloaded from server 110 to one or more devices having player module 230. Prototypes may also be downloaded to devices not having player modules 230. In some examples, installation may include downloading and implementing some, all, or none of the underlying program code of a prototype using player module 230. In other examples, a prototype may be downloaded onto a device having player module 230 and used as an application itself. In other words, a prototype developed using the described techniques may replace an application, providing the same functionality and feature as the prototyped application without a complete application. After installation, prototypes may be run when system commands in response to user input are received.

Examples of commands that may run all or part of a prototype include “vid videoNumber” (play a video file), “aud audioNumber” (play an audio file), “pic pictureNumber” (show a picture), “sleep NNN” (delay “NNN” microseconds before proceeding), “input validKeySet” (wait for a user to enter any of a previously-specified set of keys), “if ( ) command” (conditional statement as described above; if condition is met, execute the command), and the like. Other commands may be used with a prototype and those listed above are provided as examples and are not intended to be comprehensive.

By developing prototypes using the above-described processes, some tasks may be reduced such as testing, quality assurance (QA), or minimizing the use of software or program modules that may be unnecessary for a prototype. In other words, usability testing and software implementation processes may be decoupled from each other. Initial testing and functionality of the application may be evaluated without extensive implementation involvement from a programming team. In addition, rapid revision releases allow in-depth extensive testing before an application is sent for complete coding. More thorough testing results in less programming time and higher quality final products with greater usability, functionality, and appeal to a user. In some examples, the described processes also enable the reduction in the number of development and test cycles through “rapid-prototyping.” The time for performing a single development cycle may be reduced because a developer has, from a functionality, usability, and UI perspective, a clear understanding of where development time, attention, and resources should be focused. Size and complexity of applications are also reduced due to clear, concise problem definition. Once installed, users may interact with (i.e., test) a prototype (412). Content managed by the prototype may be presented as a “storyboard” or set of “flip” screens or slides. The user views the content, experiencing full functionality and may navigate through content without being affected or requiring a fully-coded underlying application on a device (e.g., mobile computing devices 116-120, personal computer 122 (FIG. 1A)). After testing the prototype, further iterative testing, development, and retesting may occur. Here, scripts are adjusted for the prototype (414). Subsequently, the prototype skins are adjusted (416). In some examples, adjusting prototype scripts and skins may include refining, replacing, or redoing art work, slides, video, audio, or other content used in the prototype. Adjusting prototype scripts and skins may be performed based on test results and target user feedback. The prototype is retested (418), after which the prototype may be enabled for user interaction and trial to determine user acceptance, UI, or usage/functionality issues, if any. In other examples, the prototype may be implemented differently than the above-described process and is not limited to the examples provided.

FIG. 4B illustrates an exemplary process for identifying user interfaces. Here, processes associated with one or more user interfaces and scripts for a prototype are identified (430). Process flows associated with the processes associated with the one or more user interfaces and scripts are identified (432). In some examples, the above-described process may be varied and is not limited to the above-described examples.

FIG. 4C illustrates an exemplary process for developing prototype scripts. Here, developing prototype scripts includes retrieving audio clips (440). In addition to audio clips, video clips may also be retrieved (442). In some examples, a developer may want to change a picture, video, or audio clip to further enhance the prototype for a target audience. However, a new prototype may be made be modified instead of developing an entirely new prototype, saving time, expense, and labor. In some examples, more, fewer, or different types of content may be retrieved. For purposes of description, “retrieved” may refer to finding or identifying content and recording the content to memory, either locally or remotely. In some examples, “retrieving” may also refer to processes for finding and recording content. Although audio and video content are described above, other types of content may be retrieved. Types of content, in addition to audio and video “clips” (i.e., files), may include graphics, images, text, or others. Retrieved content may be used to develop scripts for a prototype, as described above in connection with process 408 (FIG. 4A) (444). In other examples, the above-described process may be varied for other types of content and is not limited to the examples provided. In some examples, additional content features and functions such as cataloging, resizing, adjusting, format-conversion, and others may also be included as other processes within the above-described process, which is not limited to the example shown and described.

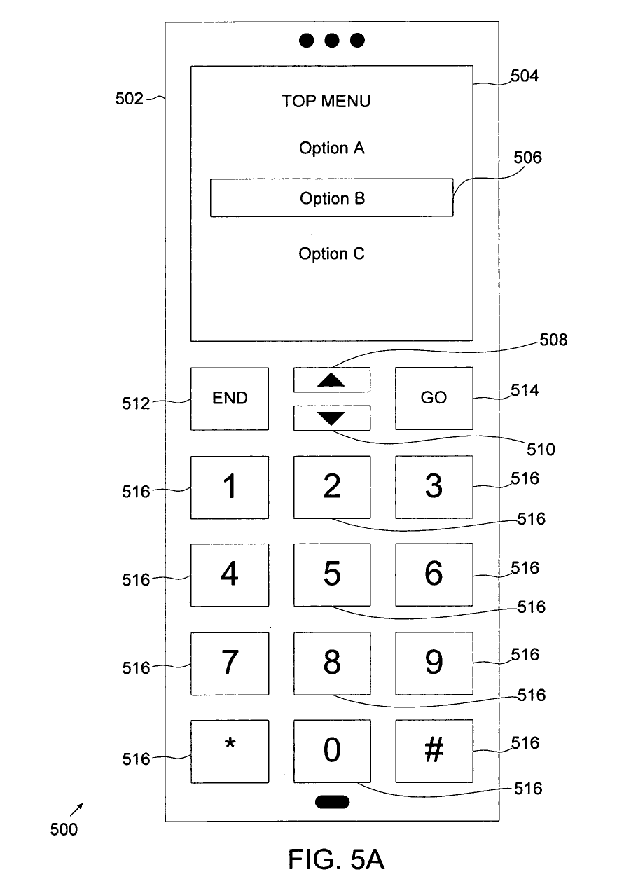

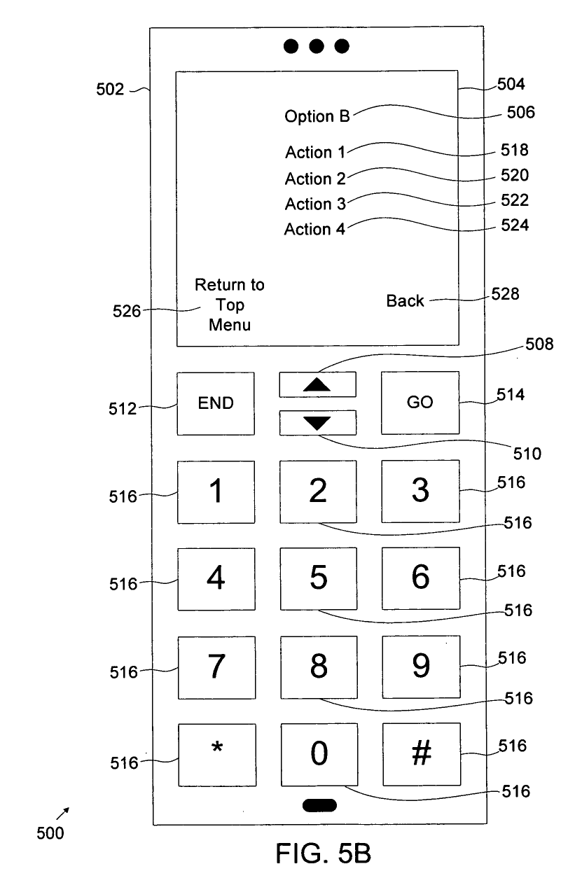

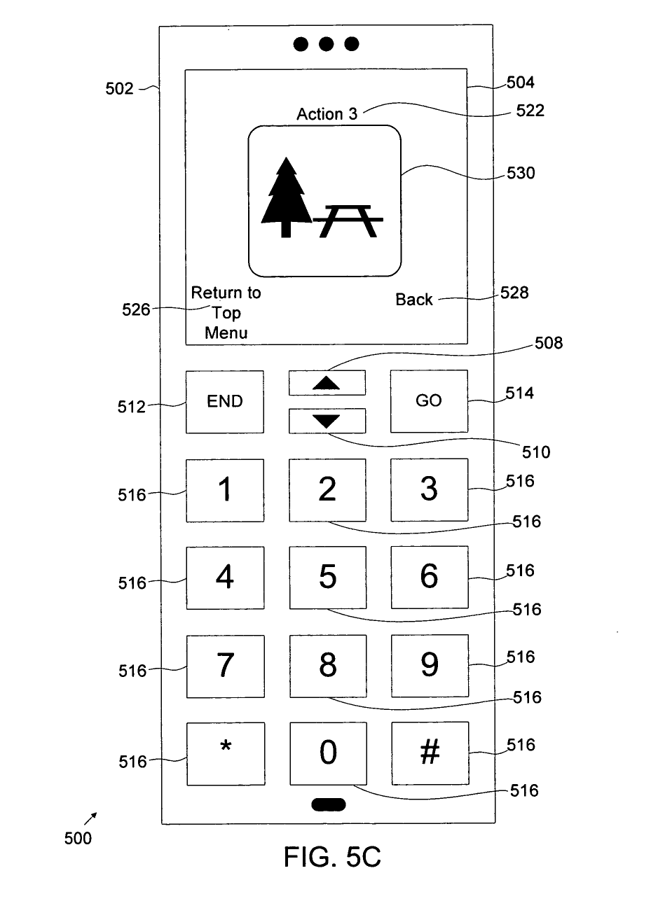

FIG. 5A illustrates a view of an exemplary prototype configured for user interaction. In some examples, prototypes may be implemented on various types of devices, including personal computers, notebook computers, handheld computing devices, and the like. Here, prototype presentation 500 may be implemented on mobile computing device 502. Mobile computing device 502 is an example of a type of device that may be used to implement the techniques describe herein. A cell phone is an example of a type of device that may be used and the described techniques are not limited to any particular type of device. Further, mobile computing device 502, which may be implemented as a cell phone, may be implemented without computational (i.e., processor) capability or reduced capability. Here, mobile computing device 502 includes display 504, display option 506, selection arrows 508-510, “end” button 512, “go” button 514, and number buttons 516. In some examples, a prototype may include a user interface presenting options for user interaction, such as the example shown on display 504. As shown, a user interface may have a “top menu” with a list of options (e.g., “Option A,” “Option B,” “Option C”). Here, display option 506 may be highlighted and selected by a user using selection arrows 508-510. Other types of user interfaces may be presented on display 504 and the user interface described may be varied. Other examples of user interfaces may include games, video or audio content, images (e.g., photos, digital camera pictures, and the like), text-based information (e.g., news articles, editorials, fiction and non-fiction articles, among others). Here, prototype presentation 500 is shown as an example of how a prototype may be presented on a device (e.g., mobile computing device 502). Other types of wireless, wired, mobile, desktop, notebook, or other presentation formats for content and information may be used and the described techniques are not limited to the example shown. For example, “views” may be developed that enable intuitive user navigation and command functions that are self-explanatory and integrated within the visual environment or “landscape” of the presentation device and display. For example, some commands options may be presented as graphical icons that fit into the background scenery of a display (e.g., seats in a ballpark that, when selected, execute various functions such as displaying additional content, dialing a number, transmitting a data package, and others). In other examples, a user interface implemented using the above-described processes may be implemented differently.

FIG. 5B illustrates an alternative view of an exemplary prototype configured for user interaction. Here, a user interface is illustrated representing a sub-menu of that shown in FIG. 5A. As an example, a user interface for a prototype having one or more top-level menus may have one or more underlying menus, including that shown here. In some examples, top-level and underlying menus may be used to provide user input, activate features, or use additional or different functionality of a prototype. Continuing the example shown in FIG. 5A, actions 518-524 and options 526-528 are shown on display 504. A user may manipulate (i.e., choose, select, activate) actions 518-528 when interacting with a prototype. By selecting display option 506, actions 518-524 and options 526-528 are presented on display 504. Once displayed, a user may select an action or an option and further interact with a prototype, resulting in other content to be displayed or scripts to be run. In other examples, prototypes may be configured differently for user interaction and are not limited to the above-described examples. For example, non-traditional UIs (e.g., object or graphical icon-drive selection in a self-explanatory presentation (e.g., seats in a ballpark, a row of books that includes a dictionary for definitions and spelling, an atlas for maps, a telephone directory for numbers and addresses, and others) may also be implemented. In some examples, a user may select a book in a library and the user's perspective on a display is changed such that application or other functionality is revealed. In other examples, UI and other user interaction techniques may be implemented differently.

FIG. 5C illustrates another alternative view of an exemplary prototype configured for user interaction. As an example, a user may select “Action 3” 522 (FIG. 5B) from a menu, resulting in the display of image 530, as shown here. FIGS. 5A-5C are exemplary illustrations of user interfaces that may be generated by a prototype on a mobile computing device (e.g., 116-120 (FIG. 1A)). In other examples, different types of user interfaces and devices may be generated by a prototype. In some examples, player modules 230 may be implemented on these devices and used to install a prototype as well as retrieve and display content when the prototype is executed (i.e., run). In still other examples, “Action 3” 522 may be different content, actions, or operations presented on a user interface by a prototype. Thus, instead of image 530, other content may be presented in response to action 522 being selected. The above-described user interface and actions and operations associated with a prototype executed on an end device (e.g., mobile computing device 502) may be varied and is not limited to the above-described examples.

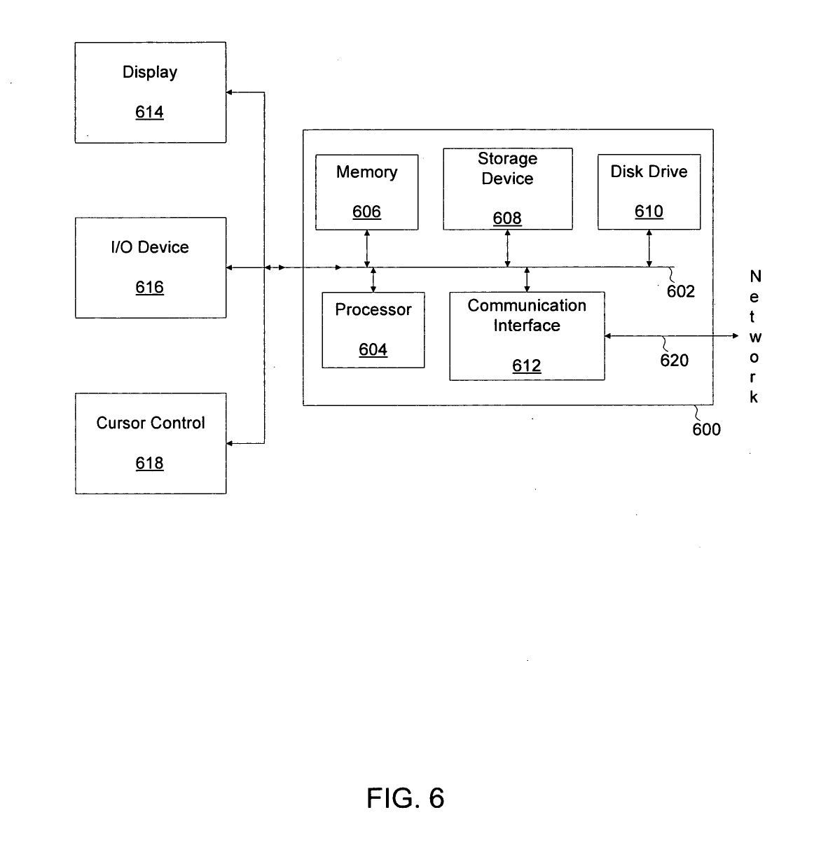

FIG. 6 is a block diagram illustrating an exemplary computer system suitable for application prototyping. In some examples, computer system 600 may be used to implement computer programs, applications, methods, or other software to perform the above-described techniques. Computer system 600 includes a bus 602 or other communication mechanism for communicating information, which interconnects subsystems and devices, such as processor 604, system memory 606 (e.g., RAM), storage device 608 (e.g., ROM), disk drive 610 (e.g., magnetic or optical), communication interface 612 (e.g., modem or Ethernet card), display 614 (e.g., CRT or LCD), input device 616 (e.g., keyboard), and cursor control 618 (e.g., mouse or trackball).

According to some examples of the invention, computer system 600 performs specific operations by processor 604 executing one or more sequences of one or more instructions stored in system memory 606. Such instructions may be read into system memory 606 from another computer readable medium, such as static storage device 608 or disk drive 610. In some examples, hard-wired circuitry may be used in place of or in combination with software instructions to implement the invention.

The term “computer readable medium” refers to any medium that participates in providing instructions to processor 604 for execution. Such a medium may take many forms, including but not limited to, non-volatile media, volatile media, and transmission media. Non-volatile media includes, for example, optical or magnetic disks, such as disk drive 610. Volatile media includes dynamic memory, such as system memory 606. Transmission media includes coaxial cables, copper wire, and fiber optics, including wires that comprise bus 602. Transmission media can also take the form of acoustic or light waves, such as those generated during radio wave and infrared data communications.

Common forms of computer readable media includes, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer can read.

In some examples of the invention, execution of the sequences of instructions to practice the invention is performed by a single computer system 600. According to some examples of the invention, two or more computer systems 600 coupled by communication link 620 (e.g., LAN, PSTN, or wireless network) may perform the sequence of instructions to practice the invention in coordination with one another. Computer system 600 may transmit and receive messages, data, and instructions, including program, i.e., application code, through communication link 620 and communication interface 612. Received program code may be executed by processor 604 as it is received, and/or stored in disk drive 610, or other non-volatile storage for later execution.

Although the foregoing examples have been described in some detail for purposes of clarity of understanding, implementations of the above-described system and techniques is not limited to the details provided. There are many alternative implementations and the disclosed examples are illustrative and not restrictive.

What is claimed:

1. A method for prototyping an application, comprising:
designing a layout of a prototype associated with the application;
creating a skin associated with the prototype, the skin being configured to provide a context associated with the prototype;
developing a script configured to execute the prototype; and
implementing the skin, the script, and the context associated with the prototype, the prototype being configured for user interaction after the script and the context are implemented.

2. The method recited in claim 1, wherein designing the layout of the prototype further comprises iteratively defining a process and a flow associated with the application.

3. The method recited in claim 1, wherein designing the layout of the prototype further comprises identifying one or more processes associated with the one or more user interfaces or the script.

4. The method recited in claim I, wherein designing the layout of the prototype further comprises identifying one or more flows associated with the one or more user interfaces or the script.

5. The method recited in claim 1, wherein designing the layout of the prototype further comprises identifying one or more user interfaces associated with the application.

6. The method recited in claim 5, wherein identifying the one or more user interfaces associated with the application further comprises finding content to associate with the one or more user interfaces.

7. The method recited in claim 6, wherein the content comprises audio content.

8. The method recited in claim 6, wherein the content comprises video content.

9. The method recited in claim 6, wherein the content comprises an image.

10. The method recited in claim 6, wherein the content comprises a file.

11. The method recited in claim 1, wherein developing the script configured to execute the prototype further comprises testing the script.

12. The method recited in claim 1, wherein developing the script configured to execute the prototype further comprises associating content with the prototype.

13. The method recited in claim 12, wherein the content is audio content.

14. The method recited in claim 12, wherein the content is video content.

15. The method recited in claim 12, wherein the content comprises one or more images.

16. The method recited in claim 12, wherein the content comprises a file.

17. The method recited in claim 1, wherein creating the skin associated with the application further comprises associating content with the application and the skin.

18. The method recited in claim 1, wherein the prototype emulates functionality of the application in response to the user interaction.

19. A system for prototyping an application, comprising:
a studio module configured to design a layout of a prototype associated with the application, to create a skin associated with the prototype, the skin being configured to provide a context associated with the prototype, and to develop a script configured to execute the prototype; and
a player module configured to implement the skin, the script, and the context associated with the prototype, the prototype being configured for user interaction after the script and the context are implemented.

20. A computer program product, the computer program product being embodied in a computer readable medium and comprising computer instructions for:
designing a layout of a prototype associated with the application;
creating a skin associated with the prototype, the skin being configured to provide a context associated with the prototype;
developing a script configured to execute the prototype; and
implementing the skin, the script, and the context associated with the prototype, the prototype being configured for user interaction after the script and the context are implemented.
